(19) United States
(12) Patent Application Publication
(10) Pub. No.: US 2026/0346471 A1
(43) Pub. Date: Nov. 5, 2026

(54) Force and Position Trajectory Recording in Hard Contact from Human Demonstration Apparatus and Method

(71) Applicant: Bota Systems AG, Zurich (CH)

(72) Inventors: Klajd LIKA, Zurich (CH); Raul CRUZ-OLIVER, Schaffhausen (CH); Eleftherios KOTSONIS, Zurich (CH); Martin WERMELINGER, Lucerne (CH)

(21) Appl. No.: 19/650,500

(22) Filed: Apr. 17, 2026

Related U.S. Application Data
(60) Provisional application No. 63/797,590, filed on Apr. 30, 2025.

(51) Int. Cl. B25J 13/08; B25J 9/00

(52) U.S. Cl. CPC B25J 13/085; B25J 9/0081

(57) ABSTRACT

An apparatus for force and position trajectory recording for robot device training. A first force torque sensor is mechanically coupled to the robot device and configured to measure a combination of contact force of the robot device and user input force applied to the robot device and to output a first signal representing the combination of contact force of the robot device and user input force applied to the robot device. A second force torque sensor mechanically coupled to the robot device configured to measure the contact force of the robot device and to output a second signal representing the contact force of the robot device. A mechanical hub connects the first and second force torque sensors. A controller is configured to receive the first signal and the second signal, apply a threshold to the first signal to obtain an adjusted first signal, and generate robot movement commands based on the adjusted first signal and the second signal.

### RELATED APPLICATION DATA

This application claims priority to Provisional Application Ser. No. 63/797,590, filed on Apr. 30, 2025, the entire disclosure of which is hereby incorporated herein by reference.

### TECHNICAL FIELD

The present invention relates to the field of force measurements to make robots easy to use and operate. Specifically, the present invention relates to the design and of an apparatus and method of use, that uses at least two force torque measuring devices to accurately control a robot movement by human demonstration through hand guidance, while allowing hard and sudden contacts. This invention allows Programming by Demonstration (PbD) of physical interaction tasks, that is a powerful approach for transferring physical skills from human demonstrations, making robot programming quicker, easier, and accessible to non-experts like factory workers. To learn from
multiple trajectories, PbD must record, parameterize and encode the demonstrated motions. The apparatus and method are designed to be retrofitted at the end-effector of any robot.

The apparatus and method of controlling the robot by demonstrating the forces and the motion in this precise way can be used in gathering data to be used in artificial intelligence techniques for robots. Particularly, they can be used for imitation learning. Teleoperation of a robot with another device can teach a robot motion and force, especially those devices that offer haptic feedback. Showing forces and torques directly on the robot comes with two advantages compared to teleoperation. First, no additional remote and expensive hardware is used. Second, it is much more intuitive and closer to the actual action compared to any teleoperated device, where the visual feedback is given to the operator through a camera or in distance.

### BACKGROUND

Traditional human demonstration through hand guidance is performed while a robot is placed in a compliant mode and the user is physically guiding the robot to desired positions or along paths. One approach is to use a force-sensitive robot with one six-axis force torque sensor or several torque sensors at the joints are used. Another way is free driving the motor. Free driving an actuator in robotics refers to allowing the actuator to move freely under external forces, typically by disabling or minimizing control effort, to enable safe and compliant interaction with the environment. However, the combination of joint based sensing, being it through motor currents or torque sensors, together with an end-effector sensor is not advised due to the limitations of joint sensing.

For example, a single 6-axis force-torque sensor is typically mounted at the robot's end-effector to capture real-time force feedback during manipulation tasks. This force data is then processed and fused with visual and linguistic representations derived from cameras and language instructions. The fusion is often accomplished through a sophisticated software module, such as a Mixture-of-Experts (MoE), which dynamically integrates the various data streams. The resulting multimodal features are used to generate force-aware robot actions, enabling the robot to perform tasks like plug insertion with improved success rates compared to vision-only models.

However, a fundamental drawback of this approach is its reliance on a single, consolidated force signal. The sensor measures the net effect of all external forces acting on the end-effector, making it incapable of distinguishing between the intentional guidance force applied by a human demonstrator during Programming by Demonstration (PbD) and the reactionary contact force resulting from the robot's interaction with the environment.

This conflated signal introduces significant ambiguity into the training data, as the system cannot decouple the user's intent from physical contact events. For example, a spike in measured force could be interpreted as either a strong user command or an unexpected collision, limiting the system's ability to respond safely and appropriately. Consequently, the capacity of an AI model trained on such data to learn precise, stable, and physically intelligent behaviors for complex, contact-rich tasks remains limited.

Hand-guiding “back-drives” the joints, so the controller senses changes in joint torques (via motor-current estimates or embedded joint-torque sensors) rather than a wrench at the tool flange. To reconstruct Cartesian forces F from joint torques T, one inverts the Jacobian.

τ=J^{T}(q)F⇒F=(J^{T})⁻¹ Equation 1

Any error in the kinematic model or joint-angle measurement propagates through (J^{T})⁻¹(Fx, Fy, Fz, τx, τy, τz) with minimal cross-coupling. By contrast, each joint-torque reading is a blended projection of all six wrench components whose unmixing relies on an ideal model. Conventional systems and methods do no cleanly separate, say, a pure Fz push from off-axis loads without sizable uncertainties.

The methods used for hand guiding have a direct influence on the ability of the robot to handle hard contact. Hard contact makes the robot not usable and recording the applied forces and torques, while hand guiding the robot is not possible. The are two main limitations in the traditional hand guidance methods described above. In situations when the contact force needs to be recorded, such as during teaching-by-demonstration, the current methods present a fundamental drawback given that such actual contact force cannot be decoupled from the force applied by the user. Therefore, existing work cannot be used to record precisely the forces demonstrated by the user.

In situations when the user is hand guiding the robot, hard contact occurs suddenly. This event cannot be properly acknowledged with the current methods, since again, the contact forced is coupled with the force input applied by the user. Not being able to acknowledge such an event prevents any feedback strategy that might allow a safe contact in this situation.

There are known methods that use a variable impedance controller to record motion trajectories through physical interaction. However, these methods are lacking the possibility to record the task specific forces simultaneously. In summary, Force-torque sensors have been widely used in robotics for measuring interaction forces. However, integrating these sensors for PbD applications presents unique challenges, particularly in separating user input forces from environmental contact forces while maintaining the ability to handle hard contacts safely.

### SUMMARY

There is a growing interest in developing more intuitive and accurate methods for capturing force and position trajectories during human demonstrations. Improved techniques could enhance the quality of data used for imitation learning and other artificial intelligence approaches in robotics. Additionally, advancements in this area may contribute to making robots easier to use and operate, particularly in industrial settings where non-expert users may need to program robots for various tasks.

As the field of human-robot interaction continues to evolve, there is an ongoing need for innovative approaches that can address the limitations of current force measurement and trajectory recording methods in PbD applications. Developing solutions that can accurately capture both user input and environmental contact forces while maintaining safety during hard contacts could significantly advance the capabilities of robots in learning from human demonstrations.

The disclosed implementations include an apparatus and method to accurately control a robot movement by human demonstration through hand guidance, while allowing hard and sudden contacts. This invention allows Programming by Demonstration (PbD) of physical interaction tasks, that is a powerful approach for transferring physical skills from human demonstrations thus making robot programming quicker, easier, and accessible to non-experts like factory workers. To learn from multiple trajectories, PbD must record, parameterize and encode the demonstrated motions. The apparatus is designed to be retrofitted at the end-effector of any robot and can be used in gathering data for machine learning for robots.

Disclosed implementations connect two 6 DOF FT sensors between the robot and the tool, with a stiff mechanical hub with a handle in between. The robot-side sensor (later referred as “sensor 0 ” herein) measures the combination of both, the contact force between environment and robot and the force input from the user. Whereas the tool side sensor (later referred as “sensor 1” herein) measures only the contact force. This arrangement allow the contact force can be acknowledged properly.

Further, disclosed implementations use the contact force signal to modify the robot behavior in an adaptive way. In particular, the robot is more damped the more it is in contact, effectively slowing down the robot when in contact. This allows sudden hard contacts. Another sensor (later referred as “sensor 2” herein) can be disposed between the user and robot to measure the force input by the user.

### BRIEF DESCRIPTION OF THE DRAWINGS

The present invention is illustrated by way of example and not limitation in the figures of the accompanying drawings in which like references indicate similar elements.

FIG. 1 illustrates the apparatus in contact with the robot, the tool and the user, in accordance with disclosed implementations.

FIG. 2 is a schematic illustration of the apparatus which consists of the three 6-axis force sensors, the connecting mechanical hub, the tool side, the robot side and the user side, in accordance with disclosed implementations.

FIG. 3 is a block diagram of the control scheme of the aforementioned method that used the apparatus developed, in accordance with disclosed implementations.

FIG. 4 illustrates the function used to threshold the force signal used for hand guidance, in accordance with disclosed implementations.

FIG. 5 illustrates the function used to vary the hand guidance proportional gain with respect to the contact force, in accordance with disclosed implementations.

FIG. 6 illustrates the function used to vary the hand guidance damping gain with respect to the contact force, in accordance with disclosed implementations.

### DETAILED DESCRIPTION

Various implementations and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment/implementation” or “an embodiment/implementation” or “another embodiment/implementation” means that a particular feature, structure, or characteristic described in conjunction with the embodiment can be included in at least one implementation. The appearances of the phrase “in one embodiment/implementation” in various places in the specification do not necessarily all refer to the same embodiment/implementation.

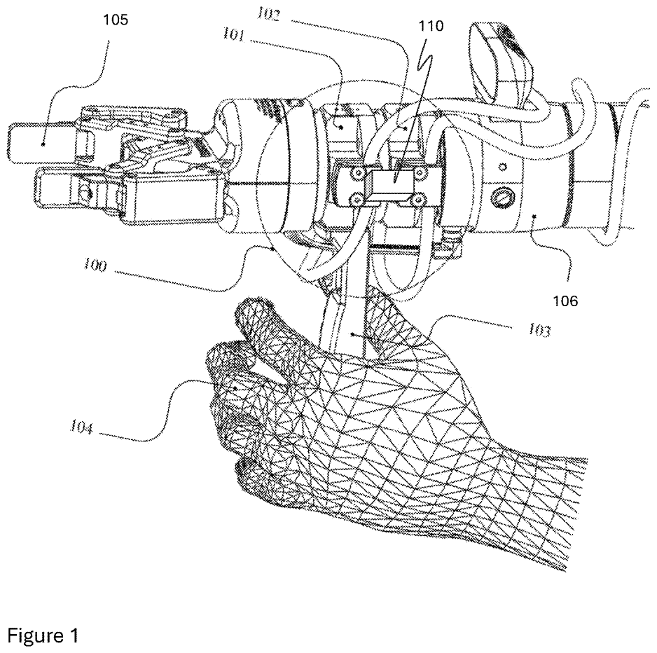

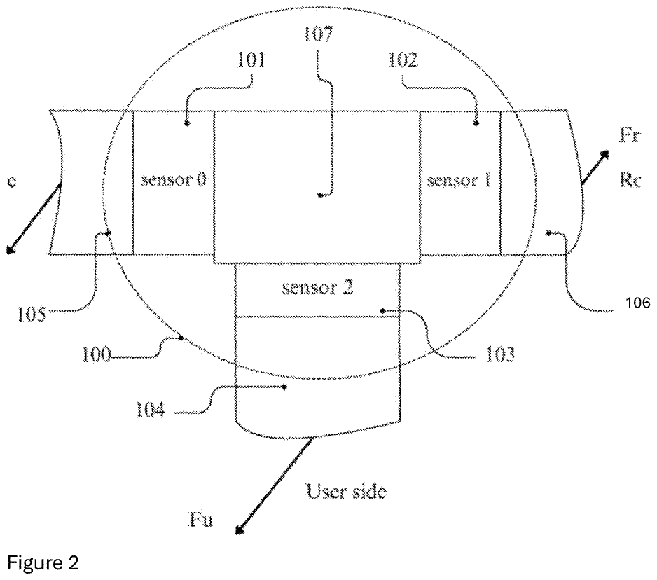

FIG. 1 illustrates an embodiment of the apparatus, a multi-sensor data acquisition suite, 100 in contact with the robotic apparatus 106, the tool 105 and the user 104. FIG. 2 illustrates a schematic of the apparatus which consists of the three 6-axis force sensors 101, 102, 103, the connecting mechanical hub 107, the tool side 105, the robot side 106 and the user side 104. Alternatively, the apparatus can have the force torque sensors in one single and monolithic sensor structure. In other words, the sensing elements of the force torque sensors can be embodied in one single piece.

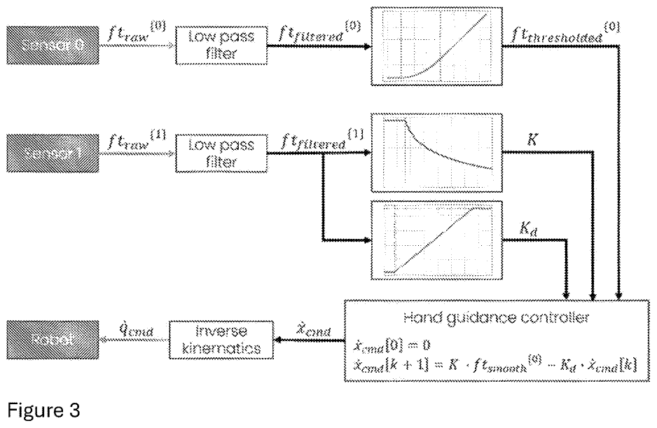

FIG. 3 is a block diagram of the control scheme of the method of use of the apparatus in accordance with disclosed implementations. The block diagram illustrates blocks representing steps in how the robot command can be generated given Force Torque (FT) measurements.

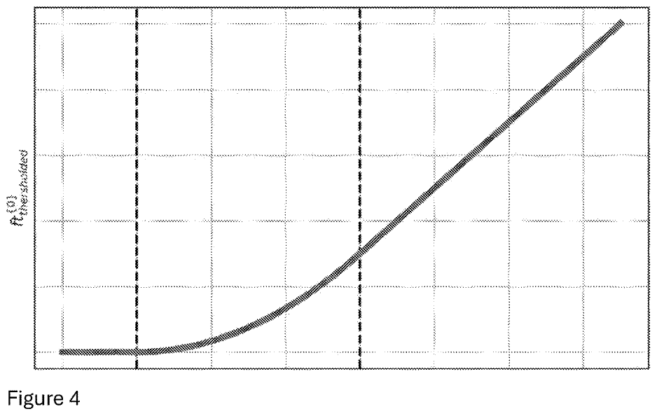

FIG. 4 illustrates the function used to threshold the force signal used for hand guidance. The thresholding effect makes the signal null below a first threshold, then smoothly transitions into a parabolic function until a second threshold, from which follow a linear function.

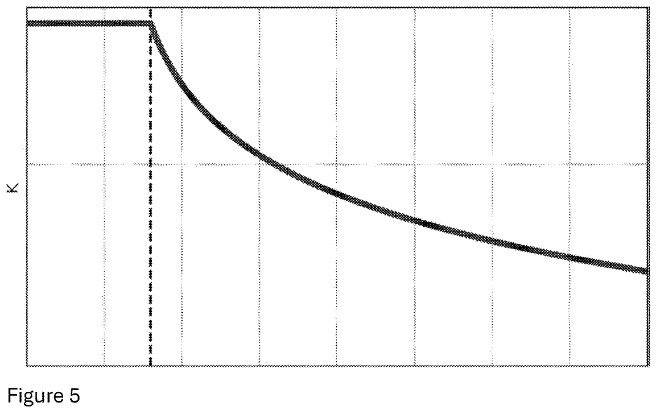

FIG. 5 illustrates the function used to vary the hand guidance proportional gain with respect to the contact force. The gain is kept constant below a certain threshold and then decreases in a hyperbolic manner towards zero as the contact force increases.

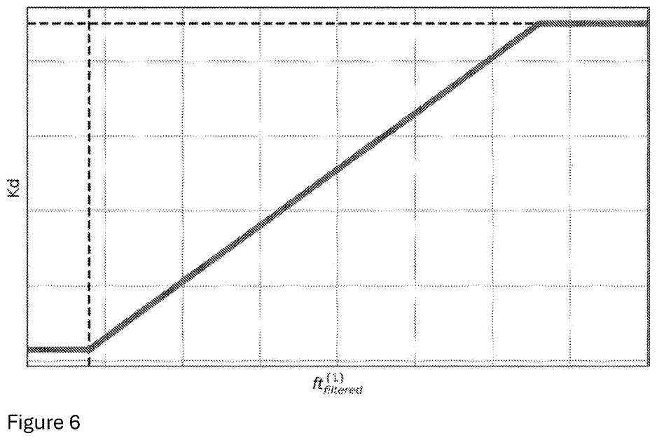

FIG. 6 illustrates the function used to vary the hand guidance damping gain with respect to the contact force. The gain is kept constant below a certain threshold and then increases in a linear fashion proportionally to the contact force until reaching a saturation at 1.0.

The disclosed embodiments allow Programming by Demonstration (PbD) of physical interaction tasks—a powerful approach for transferring physical skills from human demonstrations, making robot programming quicker, easier, and accessible to non-experts like factory workers. To learn from multiple trajectories, PbD must record, parameterize and encode the demonstrated motions. The apparatus is designed to be retrofitted at the end-effector (e.g., between the robot and a robot tool such as a “hand”) of any robot and can be used in gathering data for machine learning for robots.

Two 6 DOF FT sensors are connected between the robot and the tool, with a stiff mechanical hub with a handle in between. As shown in FIG. 1 and FIG. 2, the robot-side sensor (102) (also referred to herein as “sensor 0”) measures the combination of both, the contact force between environment and robot and the force input from the user (104). Whereas the tool side sensor (101) (also referred to herein “as sensor 1”) measures only the contact force. This arrangement allows the contact force to be isolated, measured and accounted for properly.

The contact force signal can be used to modify the robot behavior in an adaptive way. In particular, the robot can be damped in a variable manner based on the contact force. For example, greater the contact force results in increased damping to effectively slow down the robot's motion when in contact. This allows sudden hard contacts. Another sensor (referred to as “sensor 2” herein) (103) can be disposed between the user and robot to measure only the force input by the user.

The force torque signals from the 3 sensors in the described topology will measure the following magnitudes.

ƒτ⁽⁰⁾=ƒτ_{contact}+ƒτᵤₛₑᵣ

ƒτ⁽¹⁾=ƒτ_{contact}

ƒτ⁽²⁾=ƒτᵤₛₑᵣ Equation 2

The signals from sensor 0 and 1 (101, 102) are used in the control pipeline shown in FIG. 3 to enable the robot behavior needed for PbD. With reference to FIG. 3, both force signals (from sensor 0 and sensor 1) are first filtered with a low pass filter to reduce the noise levels. The signal from sensor 0 is then subject to a threshold function to provide stable signals around zero. This is needed to allow stable behavior when low forces are applied.

The thresholded signal serves as in input to a hand guidance controller structure, yielding a Cartesian twist command to the robot that is proportional to the thresholded force signal. The goal of this proportional controller, modulated by the K gain, is to make this signal form the sensor be substantially zero so the user does not feel force from the robot. This can be accomplished by tracking a null reference for the signal measured by sensor 0, which at the end of the day means making the user input force equal to the contact force. So, assuming a perfect tracking the following relationship will apply:

ƒτ⁽⁰⁾=→ƒτ_{contact}≈ƒτᵤₛₑᵣ Equation 3

In essence, such equality of contact force equal to the user input force is the fundamental key in PbD methodologies as the user would be feeling the force the robot is applying into the environment. The twist computation, apart from the mentioned proportional law, also includes a damping component, which slows down the robot movement. This intensity of the damping is controlled by a damping gain Kd.

To enable the desired stable behavior in hard sudden contacts the proportional (K) and the damping (Kd) gain are varied taking into account the contact force, which is actually the signal measured by sensor 1.

The proportional gain (K) can be varied in accordance with the function shown in FIG. 5. For example, the gain is maintained at a constant value under a certain threshold and then decreased at or above the threshold.

This control makes the robot less reactive as the contact force is increased. This behavior is desired during the transient into contact, where a spike in the contact force will produce an overreaction in the robot movement.

The damping gain (Kd) can be varied in accordance with the function shown in FIG. 6. For example, the gain is kept at a constant value below a certain threshold, and then increased linearly proportionally to the contact force, until saturating at 1.0. The saturation of 1.0 avoids creating an unstable system. The effect of increasing the damping in the direction of the contact force virtually slows down the robot in that direction, which is a desired behavior as it has come into contact.

The combination of these variable gains enables a behavior in the robot that can be intuitively described as slowing down in a controlled way when in contact but still applying the force the user requests. To compare, in a more precise way, the force applied by the user and the force the robot is exerting, The information from sensor 2 can be uses. Such a signal is purely the input from the user. Using that signal in a learning framework could be fundamental, given that without this third sensor, the only way to estimate the user force is to assume perfect tracking in the hand guidance controller, and then the equality in equation 3 would apply.

Referring again to FIG. 1, the system includes a robotic apparatus 106, a multi-sensor data acquisition suite 100, and a software-based control unit 110 for controlling data collection and management as described above (with respect to FIG. 3, for example)

The robotic apparatus 106 can include a robot arm, which may be any of a plurality of commercially available robotic manipulators (such as those from brands including Kinova™, Universal Robots™ (UR), Franka Emika™, Stäubli™, and Kuka™). Mounted at the end-effector of the robot arm is the a multi-sensor data acquisition suite 100 as described above. The multi-sensor data acquisition suite 100 provides the system's ability to achieve a “Sense of Touch” by providing direct, high-precision measurements of the interaction forces and torques at the tool center point (TCP). The multi-sensor data acquisition suite 100 is configured to provide decoupled measurements of the user input force and the environmental contact force as described above. This provides a technical improvement over systems relying on estimations from robot joint torques or single, undifferentiated force sensors.

The multi-sensor data acquisition suite 100 can (in addition to the FT sensors described above) include a plurality of sensors to capture a rich, multimodal dataset. These sensors can be, for example:

Visual Sensors, such as at least one camera configured to capture visual information (e.g., a static, third-person point-of-view (POV) 3D camera to capture the overall scene, and a wrist-mounted camera to provide an egocentric view from the robot device perspective). Tactile Sensors, e.g., a tools end effector may be equipped with tactile sensors at its “fingertips” configured to measure fine-grained contact with precision.

The control unit 110 can be communicatively coupled to the robot arm and the entire data acquisition suite 100. The control unit 110 can include a microprocessor configure to execute software instructions to synchronize and process the data streams from all sensors. The control unit 110 can include an AI data-engine configured to collect and synchronize several distinct data modalities to form comprehensive training episodes. For example, these modalities include:

Robot State Information: This comprises data streams that define the physical state of the robot at any given moment, including:
a. Joint position, velocity, and torque for each axis of the robot arm.
b. The Cartesian pose (position and orientation) and twist (linear and angular velocity) of the end-effector.
c. The Wrench representing the forces and torques measured by the end-effector apparatus.
d. Tactile sensing data from the fingertips of a gripper or the like.

Visual Information: This comprises the synchronized video feeds from the static camera, the wrist-mounted camera, and any other imaging device.

Natural Language Information: This includes the task instruction, which may be provided as text or recorded audio. This information can be stored in a structured format, such as an SQL database (242), and time-stamped to align with the corresponding robot state and visual data.

The system can provide an intuitive workflow for programming the robot through demonstration, managed via a user interface. The user can collect demonstration data using two primary methods:
Kinesthetic Teaching: The user physically grasps the handle 103 on the apparatus and manually guides the robot arm through the desired motions of a task. The system's adaptive compliance, based on the decoupled contact force signal, ensures that interactions with the environment are stable and safe, even during sudden, hard contacts.
Teleoperation: The user operates the robot from a distance, typically from a control station with a monitor displaying the camera feeds. The user controls the robot's movements using a remote input device, which may provide haptic feedback derived from the force signals measured by the apparatus.

The user interface can be designed as a “Click & Collect” application, simplifying the data collection process. The interface can allow the user to start and stop “Episode Recording,” during which all synchronized data streams are captured and stored as a single, coherent demonstration. The interface an also provide for the visualization of “Live Measurements” from the sensors and includes tools for managing the collected episodes within the SQL database.

The output of the system can be a high-quality, multimodal dataset where robot actions are precisely correlated with visual input, language commands, and, a nuanced and decoupled sense of physical force. This dataset can serve as the training foundation for a Physical AI model, enabling it to learn and replicate complex manipulation tasks with a level of physical intelligence and adaptiveness not achievable with conventional data collection methods.

1. An apparatus for force and position trajectory recording for robot device training, comprising:
a first force torque sensor mechanically coupled to the robot device and configured to measure a combination of contact force of the robot device and user input force applied to the robot device and to output a first signal representing the combination of contact force of the robot device and user input force applied to the robot device;
a second force torque sensor mechanically coupled to the robot device configured to measure the contact force of the robot device and to output a second signal representing the contact force of the robot device; and
a mechanical hub connecting the first and second force torque sensors; and
a controller configured to:
receive the first signal and the second signal;
apply a threshold to the first signal to obtain an adjusted first signal, and
generate robot movement commands based on the adjusted first signal and the second signal.

2. The apparatus of claim 1, wherein the controller is further configured to vary a proportional gain and a damping gain based on the second signal.

3. The apparatus of claim 2, wherein the controller is further configured to:
decrease the proportional gain as the second signal increases above a threshold;
and increase the damping gain as the second signal increases above a threshold.

4. The apparatus of claim 1, further comprising a handle attached to the mechanical hub, wherein the handle is configured to be grasped by a user to thereby allow the user to provide the user input force.

5. The apparatus of claim 1, wherein the controller is configured to generate the robot movement commands by calculating a Cartesian twist command based on the adjusted first signal and the second signal.

6. The apparatus of claim 1, further comprising a third force torque sensor configured to measure only the user input force.

7. The apparatus of claim 6, wherein the controller is further configured to:
receive a force signal from the third force torque sensor; and
use the force signal from the third force torque sensor to estimate the user input force separately from the contact force.

8. A method for force and position trajectory recording for robot device training, the method comprising:
measuring, by a first force torque sensor mechanically coupled to the robot device, a combination of contact force of the robot device and user input force applied to the robot device and outputting a first signal representing the combination of contact force of the robot device and user input force applied to the robot device;
measuring, by a second force torque sensor mechanically coupled to the robot device, the contact force of the robot device and outputting a second signal representing the contact force of the robot device;
wherein the first force torque sensor and the second force torque sensor are connected by a mechanical hub; and
applying a threshold to the first signal to obtain an adjusted first signal, and generating robot movement commands based on the adjusted first signal and the second signal.

9. The method of claim 8, further comprising varying a proportional gain and a damping gain based on the second signal.

10. The method of claim 8, further comprising:
decreasing the proportional gain as the second signal increases above a threshold; and
increasing the damping gain as the second signal increases above a threshold.

11. The method of claim 8, further comprising providing the user input force through a handle attached to the mechanical hub.

12. The method of claim 8, further comprising calculating a Cartesian twist command based on the adjusted first signal and the second signal.

13. The method of claim 1, further comprising measuring, by a third force torque sensor the user input force.

14. The method of claim 13, further comprising estimating the user input force separately from the contact force by the third force torque sensor.
